(19) United States
(12) Patent Application Publication
(10) Pub. No.: US 2016/0147960 A1
(43) Pub. Date: May 26, 2016

(54) APPARATUS AND METHOD FOR PROVIDING CUSTOMIZED PERSONAL HEALTH SERVICE

(71) Applicant: ELECTRONICS AND TELECOMMUNICATIONS RESEARCH INSTITUTE, Daejeon (KR)

(72) Inventors: Young-Won KIM, Daejeon (KR); Myung-Eun LIM, Daejeon (KR); Ho-Youl JUNG, Daejeon (KR); Jae-Hun CHOI, Daejeon (KR); Young-Woong HAN, Daejeon (KR); Dae-Hee KIM, Daejeon (KR); Min-Ho KIM, Daejeon (KR); Seung-Hwan KIM, Daejeon (KR)

(21) Appl. No.: 14/949,727

(22) Filed: Nov. 23, 2015

(30) Foreign Application Priority Data
Nov. 25, 2014 (KR) 10-2014-0165380
Feb. 17, 2015 (KR) 10-2015-0023863
Jul. 21, 2015 (KR) 10-2015-0103263

(51) Int. Cl. G06F 19/00

(52) U.S. Cl. CPC G06F 19/345; G06F 19/322; G06F 19/3443

(57) ABSTRACT

Disclosed herein are an apparatus and method for providing a customized personal health service based on personal health information. The apparatus includes a health information input unit for receiving individual health information, a similar case search unit for calculating weights of the health information for respective features and calculating similarities based on the weights, thus searching for similar cases, a health pattern analysis and future health prediction unit for analyzing patterns of found similar cases and predicting a health pattern of the corresponding individual, a healthcare planning unit for designing individual customized healthcare plans based on the predicted health pattern for the corresponding individual, and a healthcare knowledge base including a knowledge map required for calculation of the weights of the health information for respective features and a knowledge map required for the analysis and prediction of patterns.

### CROSS REFERENCE TO RELATED APPLICATIONS

This application claims the benefit of Korean Patent Application Nos. 10-2014-0165380, filed Nov. 25, 2014, 10-2015-0023863, filed Feb. 17, 2015, and 10-2015-0103263, filed Jul. 21, 2015, which are hereby incorporated by reference in their entirety into this application.

### BACKGROUND OF THE INVENTION

1. Technical Field

The present invention relates generally to an apparatus and method for providing a customized personal health service and, more particularly, to an apparatus and method capable of providing information suitable for the physical conditions of respective individuals, which allow a user to enter his or her health information, disease of interest, etc. via a mobile terminal or over the web, search for similar health cases, predict his or her future health, and be provided with a healthcare plan suitable for that user.

2. Description of the Related Art

Recently, with the development of medicine and science, the average lifespan of people has increased.

Together with the increased lifespan, modern people take increasing interest in their personal health, and desire to acquire devices and information that are required in order to monitor their physical conditions or improve their health.

Further, unlike the past, in which individual medical records were stored in a handwritten form, individual medical record information from medical institutions, individual health information, etc. are stored in a form suitable for easy collection, with the development of computation equipment and management systems.

As well as the computerization of medical health data from individual hospitals, the development of wearable devices enables the devices to be attached to the user's body, and to acquire and monitor personal information from his or her daily life. Accordingly, various types of medical equipment for storing life log records have been developed and used.

Preceding technologies related to the present invention include Korean Patent Application Publication No. 2001-0055569 (entitled “Cyber health management system and its operation method”), Korean Patent Application Publication No. 2002-0028036 (entitled “Service system for diagnosing and curing personal health in the wireless Internet using torsion field and operating methods of the same”), and Korean Patent Application Publication No. 2014-0022641 (entitled “Health diary service system for chronic disease based on intelligent agent technology, and method thereof”).

### SUMMARY OF THE INVENTION

Accordingly, the present invention has been made keeping in mind the above problems occurring in the prior art, and an object of the present invention is to provide an apparatus and method capable of providing a customized personal health service depending on personal health information, which allow a user to enter his or her health information, disease of interest, etc. via a mobile terminal or over the web, search for similar health cases, predict his or her future health, and be provided with a healthcare plan suitable for that user.

In accordance with an aspect of the present invention to accomplish the above object, there is provided an apparatus for providing a customized personal health service, including a health information input unit for receiving individual health information; a similar case search unit for calculating weights of the health information for respective features and calculating similarities based on the weights, thus searching for similar cases; a health pattern analysis and future health prediction unit for analyzing patterns of found similar cases and predicting a health pattern of the corresponding individual; a healthcare planning unit for designing individual customized healthcare plans based on the predicted health pattern for the corresponding individual; and a healthcare knowledge base including a knowledge map required for calculation of the weights of the health information for respective features and a knowledge map required for the analysis and prediction of patterns.

The similar case search unit may be configured to, after the weights have been calculated, search for the similar cases by calculating similarities for respective features to a health-related big DB for storing multiple personal health information cases.

The similar case search unit may include a feature-based weight calculation unit for calculating weights of the health information for respective features; and a feature-based similarity calculation unit for calculating similarities for respective features to personal health information cases stored in the health-related big DB, based on the weights calculated by the feature-based weight calculation unit, thus searching for cases similar to the current physical condition of the corresponding individual.

The feature-based weight calculation unit may calculate the weights using the knowledge map that is required for calculation of the weights of the health information for respective features and that is included in the healthcare knowledge base.

The health pattern analysis and future health prediction unit may analyze the patterns of the found similar cases using the knowledge map that is required for analysis and prediction of patterns and that is included in the healthcare knowledge base.

The healthcare knowledge base may further include knowledge related to improvement planning depending on a degree of risk of each disease, and the healthcare planning unit may design healthcare plans suitable for individual physical conditions and patterns using the knowledge related to the improvement planning depending on the degree of risk of each disease.

The apparatus may further include a health information preprocessing unit for preprocessing the individual health information input through the health information input unit.

The health information preprocessing unit may include a health information feature extraction unit for extracting health information having major features from the individual health information from the health information input unit; and a health information normalization unit for normalizing the health information extracted by the health information feature extraction unit.

The health information preprocessing unit may further include an omitted health information processing unit for processing the health information so that omitted health information is input again.

The apparatus may further include a healthcare information output unit for outputting the individual customized healthcare plans output from the healthcare planning unit.

In accordance with another aspect of the present invention to accomplish the above object, there is provided a system for providing a customized personal health service, including a health information input unit for receiving individual health information; a similar case search unit for calculating weights of the health information for respective features and calculating similarities based on the weights, thus searching for similar cases; a health pattern analysis and future health prediction unit for analyzing patterns of found similar cases and predicting a health pattern of the corresponding individual; a healthcare planning unit for designing individual customized healthcare plans based on the predicted health pattern for the corresponding individual; a healthcare knowledge base including a knowledge map required for calculation of the weights of the health information for respective features and a knowledge map required for the analysis and prediction of patterns; and a health-related big DB for collecting public medical information and individual medical health information for respective cases.

The health-related big DB may store pieces of time-series health information enabling variations in numerical values of respective pieces of health information to be detected for respective cases, and the similar case search unit may calculate similarities for respective features to the health-related big DB after calculating the weights, thus searching for similar cases.

Meanwhile, in accordance with a further aspect of the present invention to accomplish the above object, there is provided a method for providing a customized personal health service, including receiving, by a health information input unit, receiving individual health information; calculating, by a similar case search unit, weights of the health information for respective features and calculating similarities based on the weights, thus searching for similar cases; analyzing, by a health pattern analysis and future health prediction unit, patterns of found similar cases and predicting a health pattern of the corresponding individual; and designing, by a healthcare planning unit, individual customized healthcare plans based on the predicted health pattern for the corresponding individual.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing an apparatus for providing a customized personal health service according to an embodiment of the present invention;

FIGS. 2A and 2B are respectively the internal configuration diagram and the processing flowchart of a health information preprocessing unit in the apparatus for providing a customized personal health service according to an embodiment of the present invention;

FIGS. 3A and 3B are respectively the internal configuration diagram and the processing flowchart of a similar case search unit in the apparatus for providing a customized personal health service according to an embodiment of the present invention;

FIGS. 4A and 4B are respectively the internal configuration diagram and the processing flowchart of a health pattern analysis and future health prediction unit in the apparatus for providing a customized personal health service according to an embodiment of the present invention;

FIGS. 5A and 5B are respectively the internal configuration diagram and the processing flowchart of a healthcare planning unit in the apparatus for providing a customized personal health service according to an embodiment of the present invention;

FIG. 6 is a flowchart showing a method for providing a customized personal health service according to an embodiment of the present invention; and

FIG. 7 is a diagram showing a computer system in which an embodiment of the present invention is implemented.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

The present invention is intended to embody a technical spirit in which, when pieces of health information from hospitals and pieces of health information stored in real time are arranged in a single health-related big database (DB), and then a healthcare knowledge base is constructed by analyzing the health-related big DB, health variation patterns may be analyzed and future health may be predicted by searching the healthcare knowledge base for cases similar to those of individual physical conditions, and healthcare planning for improving physical conditions may also be realized.

In other words, the present invention is configured to search for similar cases based on individual health information, and analyze health patterns and predict future health based on the similar cases, thus enabling easy understanding of the current physical conditions of individuals without requiring hospital visits, and providing an improved healthcare plan fitted to predicted patterns.

The apparatus of the present invention may be mounted in or applied to a smart device, exercise equipment, a health information measuring device, or the like in various ways.

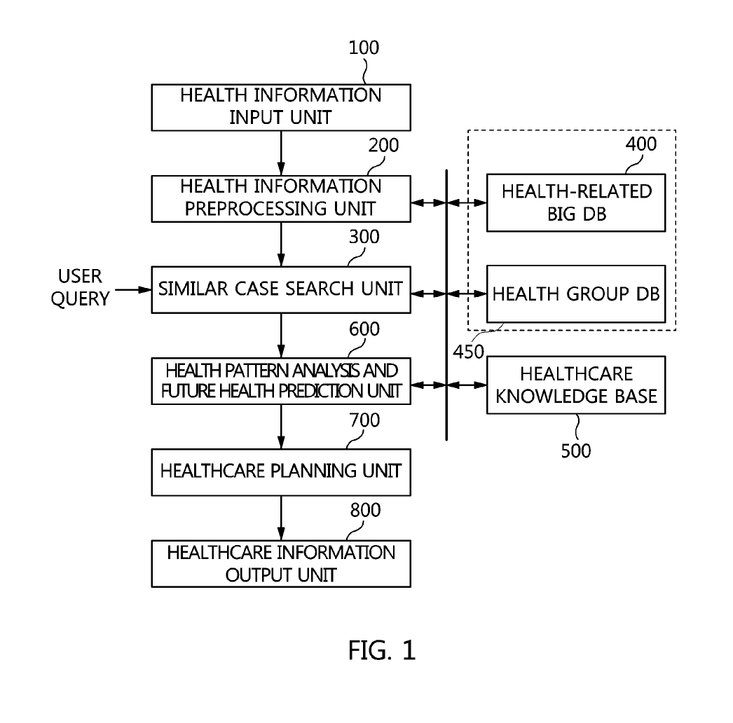

FIG. 1 is a configuration diagram showing an apparatus for providing a customized personal health service according to an embodiment of the present invention.

As shown in FIG. 1, the apparatus for providing a customized personal health service according to the embodiment of the present invention includes a health information input unit 100, a health information preprocessing unit 200, a similar case search unit 300, a health-related big DB 400, a health group DB 450, a healthcare knowledge base 500, a health pattern analysis and future health prediction unit 600, a healthcare planning unit 700, and a healthcare information output unit 800.

Here, for the convenience of description, the health-related big DB 400, the heath group DB 450, and the healthcare knowledge base 500 will be described first.

The health-related big DB 400 may store, for respective cases, medical records and health examination data collected from public health information DBs and medical institutions, or health information collected in real time through wearable health information collection devices. The health-related big DB 400 may store, for respective cases, time-series health information, from which the numerical variation of each piece of health information within a range of about a decade may be detected, rather than one-time health information that is acquired for individuals. That is, the health-related big DB 400 may be regarded as storing various types of individual health information cases.

More specifically, the health-related big DB 400 includes a set of raw health data, and may more preferably include at least one health group (-based) DB 450 separately from the raw health data set. The health group DB 450 may store data that has been processed via filtering, grouping, or a combination thereof by the health information preprocessing unit 200.

The health group DB 450 may be configured by grouping and storing in advance the raw health data stored in the health-related big DB 400 according to classification factors such as age, gender, disease, or physical condition, in order to search for similar cases in real time. The health group DB may be grouped according to a single classification factor, or may be grouped via a combination of one or more classification factors. For example, as criteria for similar physical condition groups, there may be factors, such as the gender (male or female), age (persons in their teens, 20s, 30s, . . . , 80s or older), and a specific disease (e.g. the presence or absence of high blood pressure). Further, health groups may be divided into a group in good physical condition, a group of persons at risk, etc. based on the physical condition factor. The groups may also be subdivided based on one or more conditions. As an example, a single group may be generated based on multiple conditions such as (gender=‘female’, age=‘50s’, and disease=‘high blood pressure’). Furthermore, a certain health case may be classified and stored in one or more groups. Alternatively, it is preferable to configure the health group DB 450 using parallel storage units in order to search for similar cases in real time.

Meanwhile, the health-related big DB 400 may be configured to include the health group DB 450 or may be configured as a DB separate from the health group DB. In the present invention, for the convenience of description, the health group DB is described separately from the health-related big DB, but it is also possible to manage DB entries for respective health groups as a separate table in the health-related big DB, or to group the DB entries directly from the health-related big DB and search the DB for the DB entries.

The healthcare knowledge base 500 has health feature vector weights for respective major diseases and vectors related to associations between respective features. Also, the healthcare knowledge base 500 has N recognizers for recognizing whether N major diseases (where N is some particular number of diseases) have occurred. Further, the healthcare knowledge base 500 has a knowledge map related to the analysis and prediction of the variation patterns of time-series health information. Furthermore, the healthcare knowledge base 500 has knowledge of recovery planning depending on the degree of risk for respective diseases.

In addition, the healthcare knowledge base 500 stores a major health feature association map for each disease, an inter-disease association map, a health feature level map, an associated feature map for each major health feature, a planning map for each disease, etc., which are generated by analyzing the results of filtering the health data in the health-related big DB 400, and those maps are products resulting from mining the health-related big DB 400.

The configuration of the healthcare knowledge base is implemented in such a way as to receive data from public health records, index an associative relationship between a disease and another disease (e.g. an associative relationship between strokes and high blood pressure) via association mining in a data preprocessing procedure, and represent the resulting indices in the form of a map (i.e. the form of a table or a network), and also index an associative relationship related to major health features for respective diseases (e.g. associative relationships between each disease and ages and genders) and represent the resulting indices in the form of a map. That is, the associative relationships between each disease and features are mined and the associative relationships between each disease and other diseases are mined, and thus the results of the mining are stored in the healthcare knowledge base. In this way, it is possible to configure maps by assigning levels to respective health features, and it is also possible to configure associated feature maps for respective major health features or planning maps for respective diseases.

In the present invention, association maps, level maps, feature maps, and planning maps may be freely configured between diseases, between health features, or between combinations thereof, and such maps are collectively referred to as ‘knowledge maps’.

Below, individual components of the apparatus for providing a customized personal health service according to an embodiment of the present invention will be described in detail.

First, the health information input unit 100 functions to receive medical record data and health examination data that are acquired from medical examinations and healthcare received in medical institutions, and personal health information (e.g. gender, age, height, weight, blood pressure, blood sugar, body mass index (BMI), etc.) that is acquired through wearable health measuring smart devices, fitness equipment, health level measuring equipment, etc.

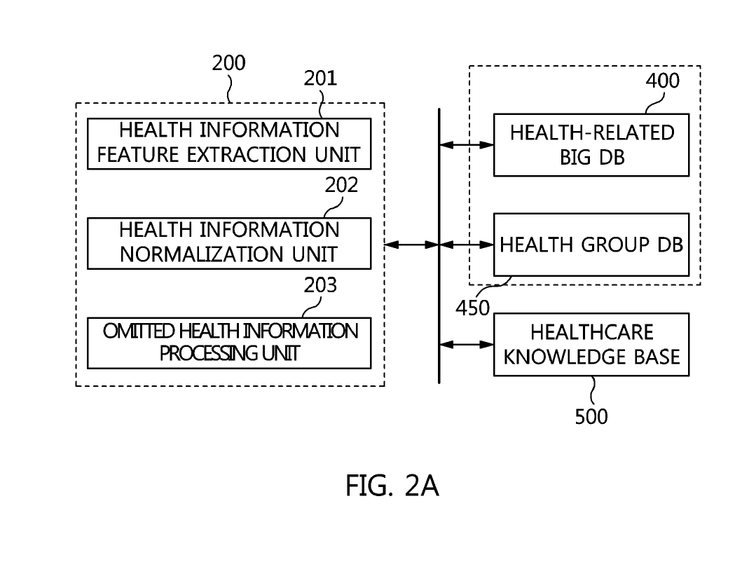

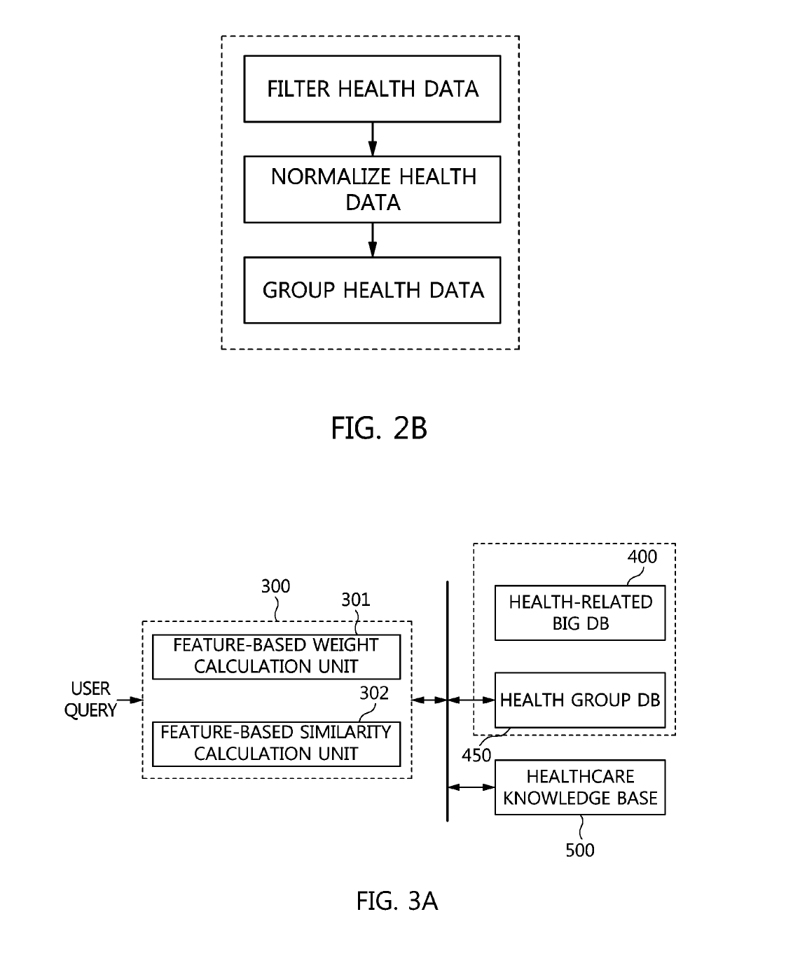

FIGS. 2A and 2B are respectively the internal configuration diagram and the processing flowchart of the health information preprocessing unit in the apparatus for providing a customized personal health service according to an embodiment of the present invention.

As shown in FIGS. 2A and 2B, the health information preprocessing unit 200 includes a health information feature extraction unit 201, a health information normalization unit 202, and an omitted health information processing unit 203.

The health information preprocessing unit 200 converts individual health information received from the health information input unit 100 into information that may be used by the similar case search unit 300, the health pattern analysis and future health prediction unit 600, and the healthcare planning unit 700, and may convert the health information into a data format suitable for input to the healthcare knowledge base 500.

Further, the health information preprocessing unit 200 extracts health information having major features from the individual health information received from the health information input unit 100, normalizes the extracted health information, and supports a user in re-inputting the omitted health information.

The health information feature extraction unit 201 extracts health information having major (or valid) features from the individual health information received from the health information input unit 100.

The user's health information contains information about various features. Further, the healthcare knowledge base 500 stores major feature maps that significantly influence respective diseases. When a disease selected by the user through the health information input unit 100 is high blood pressure, there is a list of features (factors) that significantly influence the high blood pressure. The health information feature extraction unit 201 fetches the feature list (e.g. systolic blood pressure, diastolic blood pressure, a BMI, waist-to-hip-ratio, a hyperlipidemic value, etc.) from the healthcare knowledge base 500, selects only relevant features from the health information input by the user, and then extracts health information features. If the name of a disease selected by the user or a disease input by the user as a disease of interest is not present in the feature list, major features corresponding to preset major diseases (chronic diseases: high blood pressure, diabetes, myocardial infarction, hyperlipidemia, etc.) are selected.

The health information normalization unit 202 normalizes the health information extracted by the health information feature extraction unit 201. The user's health information is information including time-series data having various lengths, and may include some fields indicating an integer type or a ‘decimal number’ type depending on health features, and some health information may also contain survey data in a form such as “Yes” or “No”. Therefore, a procedure for normalizing such data having various lengths and formats (into the form of a real number between 0 and 1 or between −1 and 1) is required. Alternatively, when respective users have different time-series lengths (e.g. data for three years, data for five years, etc.), if the minimum time-series length of data required for the analysis of a specific disease is 5, a procedure for normalizing time-series lengths using interpolated values, representative values, or the like so that the time-series lengths are equal to or greater than 5 is required. The component for performing such a procedure is the health information normalization unit 202.

The omitted health information processing unit 203 processes omitted information when some health information is omitted. When health information is input or collected by various types of health information input (or collection) devices, health information may be omitted, and thus the omitted health information processing unit 203 searches for the omitted health information and performs processing so that the omitted health information is input again. In this procedure, when health information to be input by the user is omitted, an interface that prompts the user to input the information again may be activated. Alternatively, in order to process an omitted portion, a procedure for compensating for omitted information by applying interpolation, inserting an average value, or combining interpolation and averaging based on the input time-series health examination data may be undertaken. This procedure is performed by the omitted health information processing unit 203.

As shown in FIG. 2B, the health information preprocessing unit 200 performs health data filtering, and stores a major health feature association map for each disease, an inter-disease association map, a health feature level map, an associated feature map for each major health feature, a planning map for each disease, etc., which are generated by analyzing the results of filtering the health data in the health-related big DB 400, in the healthcare knowledge base 500. Here, the major health feature association map for each disease, the inter-disease association map, the health feature level map, the associated feature map for each major health feature, the planning map for each disease, etc. are products resulting from mining the health-related big DB 400.

The health-related big DB 400 is a data set in which the health data of various users is collected, and which contains time-series data having various lengths. In the health-related big DB 400, some health information may be omitted, some fields of the health-related big DB 400 may indicate an integer type or a decimal number type depending on health features, and some health information may also contain survey data in a form such as “Yes” or “No”. Therefore, in the procedure for generating the healthcare knowledge base 500 from the health-related big DB, which includes data having various lengths and various forms, the health information preprocessing unit 200 may require a procedure for normalizing some data (into the form of a real number between 0 and 1 or between −1 and 1) or may replace omitted data with statistical values such as the average value or the median value of the corresponding data present in similar cases. Alternatively, some health features may require a procedure for densely interpolating the time interval or the frequency between pieces of specific time-series data and then generating median values.

Then, in order to search for similar cases in real time, as described above, the health-related big DB 400 is divided into pieces of user data having similar cases, and the divided user data is stored. At this time, a grouping procedure for dividing health information into groups that characterize similar physical conditions is undertaken, wherein criteria for similar physical condition groups may be gender, age, etc., and may also be a specific disease such as the presence or absence of high blood pressure. Further, groups may be divided into a group in good physical condition, a group of persons at risk, etc. using a physical condition classifier or the like. Furthermore, groups may be subdivided based on one or more terms.

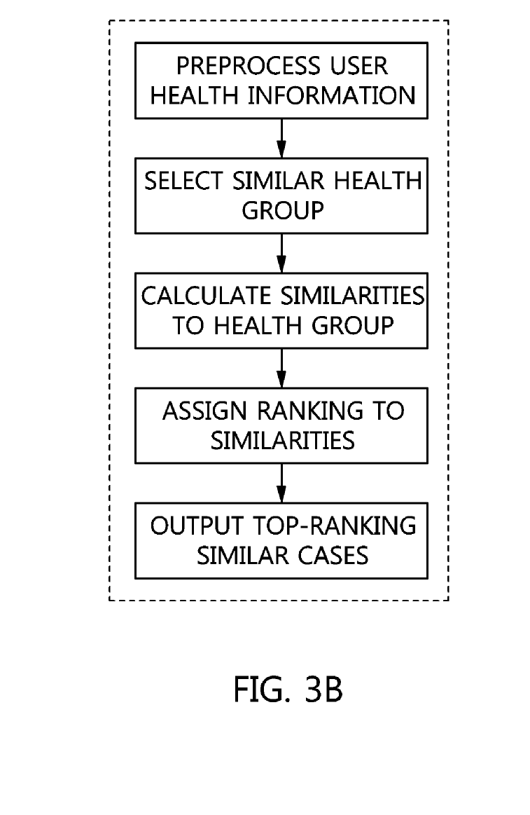

FIGS. 3A and 3B are respectively the internal configuration diagram and the processing flowchart of the similar case search unit in the apparatus for providing a customized personal health service according to an embodiment of the present invention.

As shown in FIG. 3A, the similar case search unit 300 calculates weights of health information, output from the health information preprocessing unit 200, for respective features, and searches the health group DB 450, in which health information is divided into user groups having similar physical conditions and in which user groups having similar cases are separately stored, for cases similar to the current physical condition of the corresponding user, based on the calculated weights. Further, the similar case search unit 300 may search for one or more cases similar to the current physical condition of the corresponding user.

In other words, it may be understood that the similar case search unit 300 calculates weights and similarities for respective features of the health information and then searches the health group DB 450 for similar cases based on the weights and the similarities. For this, the similar case search unit 300 includes a feature-based weight calculation unit 301 and a feature-based similarity calculation unit 302.

Here, the feature-based weight calculation unit 301 calculates weights for respective features of health information. The feature-based weight calculation unit 301 may assign different weights for respective health information features. As the preprocessing procedure of FIG. 2 is performed, major features required to search for similar cases have been selected, and normalization for the analysis of the features has been completed. Then, similarities to the health information of the user are calculated for individual health cases belonging to an extracted similar case group. A 1:1 similarity is calculated using information about an associated feature weight for each disease (e.g. for diabetes, blood sugar has a weight of 0.8 and age has a weight of 0.3), extracted from the healthcare knowledge base. Here, the calculation of the weights for respective features is performed by the feature-based weight calculation unit 301.

For example, ‘blood sugar level*0.8’ is a value obtained by applying weights for respective features, and values obtained by applying weights for respective features of the user's health information are compared with values obtained by applying weights for respective features of the similar case group. Values indicating similarity to the cases belonging to the similar case group are calculated using a similarity formula. Here, the calculation of the similarity values is performed by the feature-based similarity calculation unit 302.

Meanwhile, the similar case search unit 300 may search for a single similar case, but may also search for multiple similar cases if necessary. Also, the similar case search unit 300 according to the present invention is not limited to the configuration of the feature-based weight calculation unit 301 and the feature-based similarity calculation unit 302, but may be freely implemented using any configuration as long as the configuration is capable of performing a procedure for searching for health cases similar to the user's health case as follows.

More specifically, the similar case search unit 300 includes a procedure for searching for health cases characterizing a physical condition similar to that of the user, wherein the procedure may be divided into the step of extracting a group of health cases similar to the health information of the user from the health group DB 450, and the step of calculating similarities between the health information of individual health cases in the extracted similar health case group and the user's health information in a 1:1 manner and assigning ranking to the similarities.

In greater detail, the user's health information, which has been input in relation to the disease of interest and associated health features, is converted into group information. For example, when a blood pressure level is 120, it is converted into information about the group (e.g. group P3) in which the user's blood pressure level of 120 falls if 10 groups, P1 to P10, indicating blood pressure levels, are generated via grouping and the health cases of the 10 groups are stored in the health group DB 450. Since the health group DB 450, which is where similar cases are searched for, stores the grouped health information, a procedure for converting the health information of the user into group information is also required.

Based on the health information of the user converted into the group information, data about the group matching the health information is extracted from the health group DB 450. For example, assuming that the user's input values are ‘age: 33, blood sugar: 115, blood pressure: 123, and disease of interest: diabetes’, and, according to the healthcare knowledge base, diabetes is related to two factors, namely age and blood sugar level, health cases matching ‘age: 30s’ and ‘blood sugar level: fifth group’ are extracted as the user's similar case group from the health group DB 450.

As shown in FIG. 3B, the similar case search unit 300 first inputs the user's health information and disease of interest as queries from the user. Next, the user's health information input by the user is preprocessed. This procedure is similar to the health data filtering of FIG. 2, and is configured to perform processing when the health feature of the user to be input is omitted, the normalization of health feature values, or the interpolation of time-series health information.

Next, major health feature information associated with the disease of interest input by the user is referred to in the major health feature association map for each disease, which is stored in the healthcare knowledge base 500. The group in which cases similar to the user are to be searched for is selected from the health group DB 450 using the user's disease of interest and the user's health information. Then, similarities between the health information of the cases of the group selected from the health group DB and the user's health information are calculated. After the similarities have been calculated, the ranking of the similarities is calculated and assigned using information about weights for respective health features, stored in the healthcare knowledge base, and a preset number, designated in the system, of top-ranking similar cases are output.

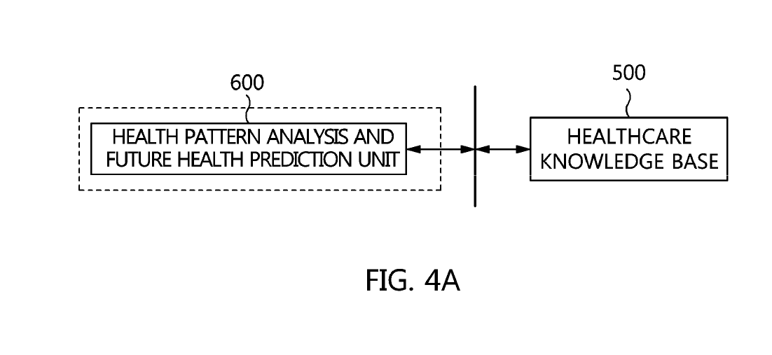

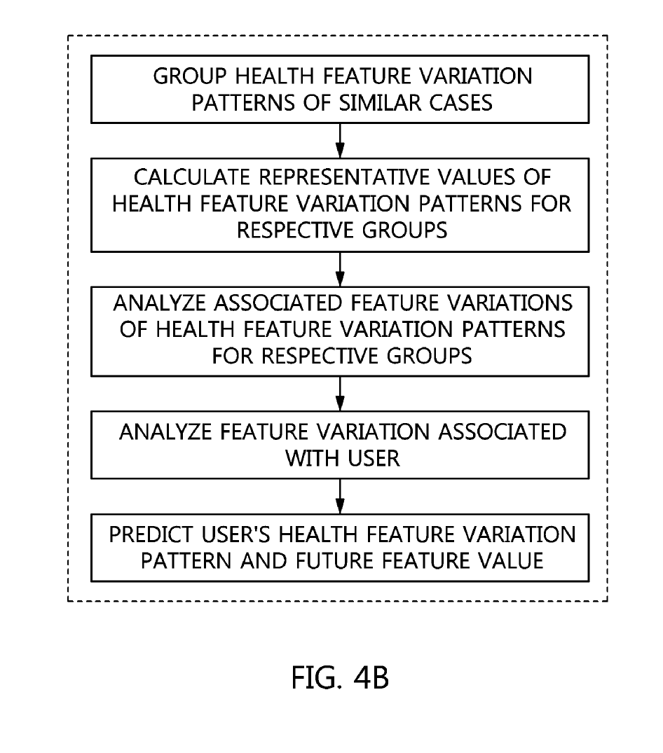

FIGS. 4A and 4B are respectively the internal configuration diagram and the processing flowchart of the health pattern analysis and future health prediction unit in the apparatus for providing a customized personal health service according to an embodiment of the present invention.

As shown in FIG. 4A, the health pattern analysis and future health prediction unit 600 may perform matching and recognition of cases similar to the physical condition of the user, which have been found by the similar case search unit 300, based on the knowledge map related to the analysis and prediction of health information variation patterns and stored in the healthcare knowledge base 500.

Further, the health pattern analysis and future health prediction unit 600 may extract features associated with the user (e.g. drinking, smoking, exercise, stress factors, presence or absence of hyperlipidemia, or the like) from the user's input health information, analyze variations both in the user's extracted associated features and in the associated features of the found similar cases, and match the associated features of the found similar cases with the user's associated features based on a comparison. By means of this method, the user's health feature variation patterns and future health feature values may be predicted.

As shown in FIG. 4B, variation patterns are analyzed for respective health features of the similar cases, wherein the health features include a BMI, blood pressure, blood sugar level, cholesterol level, etc. and denote health information significantly used to determine a physical condition and a disease. A procedure for grouping time-series variations for respective health features is undertaken, and this grouping may be performed to divide the time-series variations into a group in which blood pressure levels for five years are continuously recorded to fall within a normal range, a group in which the blood pressure levels for five years are recorded to fall within the range of risk degrees, and a group in which the blood pressure levels are improved from the risk degree range to the normal range.

In a procedure for calculating representative values of health feature variation patterns for respective groups, values representing the variation patterns of slightly different time-series values in respective groups are calculated. Simply, the representative values may be indicated by the flow of average values, and values capable of representing the features of groups are calculated using the flow of median values, the start point and end point of the values, the slope of the variation between the start point and the end point, the amount of variation, or the like.

After the procedure for calculating the representative values of the health feature variation patterns for respective groups has been terminated, the variation patterns identified for respective groups may be obtained.

The procedure for analyzing associated feature variations of health feature variation patterns for respective groups is a procedure for analyzing the life patterns of similar case groups. For example, with respect to a group having a dangerous blood pressure level, the procedure is intended to analyze the current states of health features associated with blood pressure, such as diet, exercise, stress factors, smoking, and high blood pressure heritability. Maps of health features (e.g. drinking, smoking, exercise, stress factors, presence or absence of hyperlipidemia, etc.) associated with each health feature (e.g. blood pressure) are referred to in the healthcare knowledge base 500.

The user's associated features (e.g. drinking, smoking, exercise, stress factors, presence or absence of hyperlipidemia, etc.) are extracted from the health information input by the user, and are compared and matched with the results of analyzing variations in the associated features of a similar case group. From the associated features, the associated feature variation pattern that is the most similar to that of the user is found and is predicted as a representative value of the health feature (blood pressure) of the similar case group having the associated feature (drinking, smoking, etc.) variation pattern. By using this method, the health feature variation patterns and future health feature values of the user are predicted.

In other words, the health pattern analysis and future health prediction unit 600 functions to group the health feature variations of the similar cases depending on the patterns, calculate the representative values of the health feature variation patterns for respective groups, analyze variations in the associated features of the health feature variation patterns for respective groups, analyze variations in the user's associated features, and predict the health feature variation patterns and the future feature values of the user.

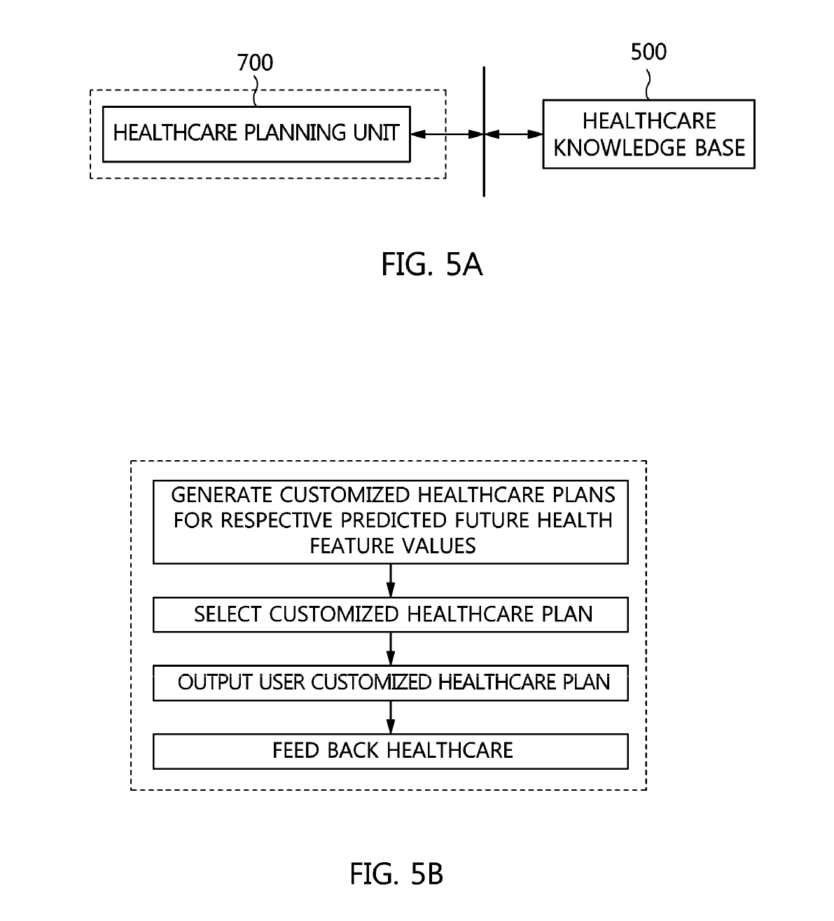

FIGS. 5A and 5B are respectively the internal configuration diagram and the processing flowchart of the healthcare planning unit in the apparatus for providing a customized personal health service according to an embodiment of the present invention.

As shown in FIG. 5A, the healthcare planning unit 700 may receive the results of the health pattern analysis and future health prediction unit 600 and generate information required to improve the health patterns of the corresponding individual, analyzed based on the healthcare knowledge base 500. In other words, the healthcare planning unit 700 may design a healthcare plan suitable for individual physical conditions and patterns using the knowledge of the improvement planning depending on the degree of risk of each disease, stored in the healthcare knowledge base 500.

Further, the healthcare planning unit 700 designs customized healthcare plans suitable for various individual physical conditions and patterns via combinations with the health feature level maps and the planning maps for respective diseases, stored in the healthcare knowledge base 500, based on the user's health feature variation patterns and future health feature values predicted by the health pattern analysis and future health prediction unit 600.

As shown in FIG. 5B, the healthcare information output unit 800 may output the customized healthcare plans suitable for individual physical conditions and patterns to the outside of the apparatus via a user display device or the like.

The healthcare knowledge base 500 stores health feature level maps, planning maps for respective diseases, etc., and the user generates customized plans in conformity with predicted numerical values of health features with reference to the stored maps. The health feature level maps store information about criteria for the normal, risk and abnormal ranges for major health features. For example, information about the normal range, the risk range, and the abnormal range of blood pressure is stored in the maps, and information about the normal range and the abnormal range of blood sugar is stored in the maps. In the planning maps for respective diseases, information about the diet, exercise, and life habits required to treat a specific disease is stored. As examples of the planning maps for respective diseases, a group of food prohibited from being eaten by diabetics and a method for calculating suitable caloric intake depending on height and weight are stored.

The health feature variation patterns predicted for individuals are combined with the health feature level maps and planning maps for respective diseases, which are stored in the healthcare knowledge base, and thus various customized healthcare plans are generated. Among various healthcare plans, a healthcare plan suitable for each individual may be selected. Then, the selected individual customized healthcare plan is output. For the selected customized healthcare plan, a function of feeding back the actual healthcare activities that were performed and variation in the user's health feature may be additionally included.

Further, the healthcare information output unit 800 outputs the individual customized healthcare plan from the healthcare planning unit 700 to the outside of the apparatus. Furthermore, the healthcare information output unit 800 may output the results of analyzing and predicting patterns obtained by searching for cases similar to the personal health information input from the health information input unit 100.

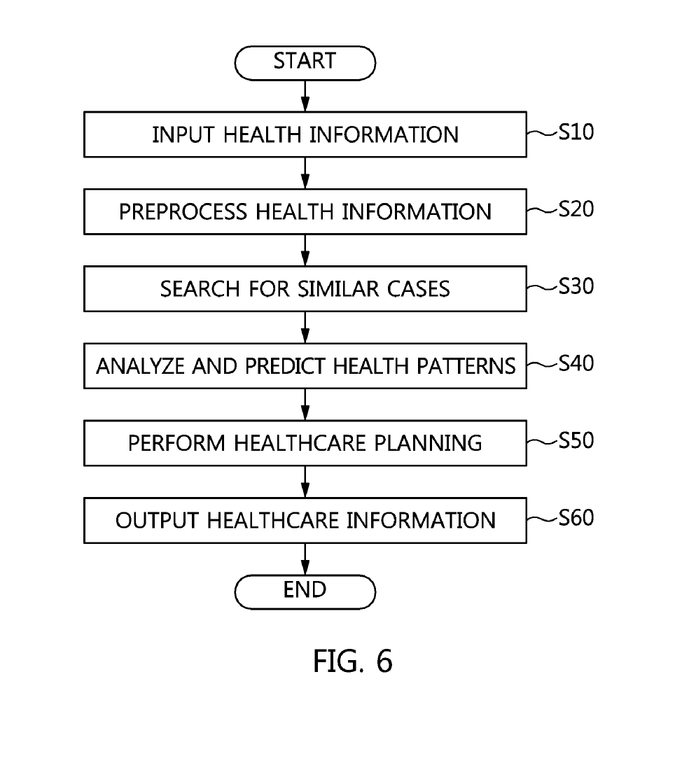

FIG. 6 is a flowchart showing a method for providing a customized personal health service according to an embodiment of the present invention.

First, the health information input unit 100 receives individual health information (e.g. gender, age, height, weight, blood pressure, blood sugar, a BMI, etc.) through various health information input (or collection) devices or collection paths at step S10.

Then, the health information preprocessing unit 200 preprocesses the individual health information received from the health information input unit 100 at step S20. Here, the health information preprocessing unit 200 extracts and normalizes health information having major features among the received health information. Of course, when health information is omitted, the omitted health information may be input again by the user.

Thereafter, the similar case search unit 300 calculates weights of the preprocessed health information for respective features, calculates similarities to respective features of various personal health information cases present in the health group DB 450, based on the weights, and then searches for one or more similar cases at step S30.

Next, the health pattern analysis and future health prediction unit 600 analyzes the patterns of the similar cases found by the similar case search unit 300 and predicts the health patterns for the corresponding individual, by using knowledge maps that are related to the analysis and prediction of the health information variation patterns and that are stored in the healthcare knowledge base 500, at step S40.

Thereafter, the healthcare planning unit 700 is configured to, when the results from the health pattern analysis and future health prediction unit 600 are received, design healthcare plans suitable for individual physical conditions and patterns using the knowledge of improvement planning depending on the degree of risk for each disease, stored in the healthcare knowledge base 500, at step S50.

Thereafter, the healthcare information output unit 800 outputs healthcare information (i.e. the healthcare plans), received from the healthcare planning unit 700, at step S60.

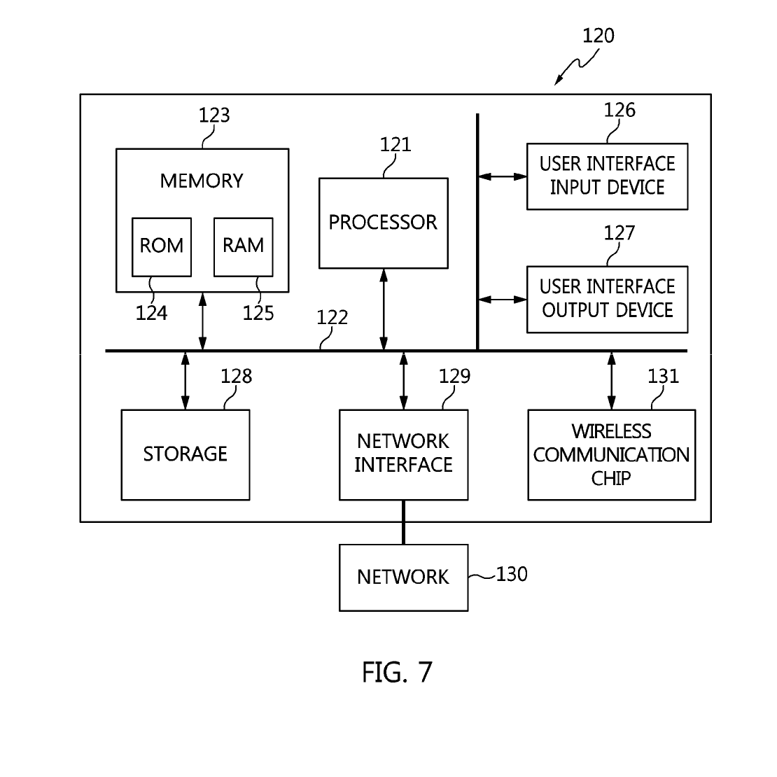

Meanwhile, the above-described embodiment of the present invention may be implemented in a computer system. As shown in FIG. 7, a computer system 120 may include one or more processors 121, memory 123, a user interface input device 126, a user interface output device 127, and a storage 128, which communicate with each other through a bus 122. The computer system 120 may further include one or more network interfaces 129 connected to a network 130. Each of the processors 121 may be a central processing unit (CPU) or a semiconductor device for executing processing instructions stored in the memory 123 or the storage 128. Each of the memory 123 and the storage 128 may be any of various types of volatile or non-volatile storage media. For example, the memory 123 may include Read Only Memory (ROM) 124 or Random Access Memory (RAM) 125.

Further, when the computer system 120 is implemented in a small-sized computing device in preparation for the Internet of Things (IoT) age, if an Ethernet cable is connected to the computing device, the computing device may function as a wireless sharer, so that a mobile device may be coupled in a wireless manner to a gateway to perform encryption/decryption functions. Therefore, the computer system 120 may further include a wireless communication chip (WiFi chip) 131.

Therefore, the embodiment of the present invention may be implemented as a non-temporary computer-readable storage medium in which a computer-implemented method or computer-executable instructions are recorded. When the computer-readable instructions are executed by a processor, the instructions may perform the method according to at least one aspect of the present invention.

In accordance with the present invention having this configuration, when personal health information is input from a mobile device, a treadmill, wearable medical equipment, etc., similar cases may be easily searched for and patterns may be easily analyzed, thus rapidly and conveniently acquiring analyzed data and future-predicted data for personal health patterns.

Further, the present invention may provide individual customized plans to improve health.

Furthermore, the present invention may easily and conveniently acquire information about modern users' physical conditions in their busy lives, and may also easily obtain healthcare plan information customized for analyzed and predicted physical conditions, and thus the present invention may be applied to various systems, devices, etc.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for providing a customized personal health service, comprising:
a similar case search unit for searching a health group database for one or more similar cases, based on individual health information; and
a health pattern analysis and future health prediction unit for predicting a personal health pattern from found similar cases,
wherein the similar cases are searched for in a health group database that stores pieces of time-series health information for respective cases, the time-series health information enabling variations in numerical values of respective pieces of health information within a range of a predetermined period to be detected.

2. The apparatus of claim 1, wherein the health group database comprises medical records and medical examination data, collected from public health information databases and medical institutions, and pieces of health information, collected in real time through wearable health information collection devices, or a combination thereof.

3. The apparatus of claim 1, wherein:
the similar case search unit is configured to calculate weights for respective health information features, based on a knowledge map that is related to weights for respective health information features and that is included in a healthcare knowledge base, and
the health pattern analysis and future health prediction unit is configured to analyze patterns of the found similar cases, based on a knowledge map that is required for analysis of a variation pattern of the time-series health information and for prediction of future health and that is included in the healthcare knowledge base.

4. The apparatus of claim 3, wherein the healthcare knowledge base comprises health feature vector weights for respective major diseases, vectors related to associations between respective features, recognition information indicating whether multiple major diseases have occurred, a knowledge map required for analysis of a variation pattern of time-series health information and for prediction of future health, knowledge related to improvement planning depending on a degree of risk of each disease, and a knowledge map related to weights for respective health information features, or a combination thereof.

5. The apparatus of claim 4, wherein the health pattern analysis and future health prediction unit predicts a health pattern of a corresponding individual by performing matching and recognition of the one or more similar cases found by the similar case search unit, based on the knowledge map that is required for analysis of the variation pattern of time-series health information and for prediction of future health and that is included in the healthcare knowledge base.

6. The apparatus of claim 4, wherein the health pattern analysis and future health prediction unit predicts the health pattern of a corresponding individual by analyzing patterns of the similar cases found by the similar case search unit, based on the knowledge map that is required for analysis of the variation pattern of time-series health information and for prediction of future health and that is included in the healthcare knowledge base.

7. The apparatus of claim 4, further comprising a healthcare planning unit for designing and providing healthcare plans suitable for individual physical conditions and patterns, based on the knowledge that is related to improvement planning depending on a degree of risk of each disease and that is included in the healthcare knowledge base.

8. A method for providing a customized personal health service, comprising:
searching a health group database for one or more similar cases, based on individual health information; and
predicting a personal health pattern from found similar cases,
wherein the similar cases are searched for in a health group database that stores pieces of time-series health information for respective cases, the time-series health information enabling variations in numerical values of respective pieces of health information within a range of a predetermined period to be detected.

9. The method of claim 8, wherein:
searching the health group database for one or more similar cases comprises calculating weights for respective health information features, based on a knowledge map that is related to weights for respective health information features and that is included in a healthcare knowledge base, and
predicting the personal health pattern comprises analyzing patterns of the found similar cases, based on a knowledge map that is required for analysis of a variation pattern of the time-series health information and for prediction of future health and that is included in the healthcare knowledge base.

10. The method of claim 9, wherein predicting the personal health pattern further comprises, based on a knowledge map that is required for analysis of a variation pattern of the time-series health information and for prediction of future health and that is included in the healthcare knowledge base:
predicting a health pattern of a corresponding individual by performing matching and recognition of the found one or more similar cases; and
predicting the health pattern of the corresponding individual by analyzing patterns of the found one or more similar cases.

11. The method of claim 9, further comprising designing and providing healthcare plans suitable for individual physical conditions and patterns, based on knowledge that is related to improvement planning depending on a degree of risk of each disease and that is included in the healthcare knowledge base.

12. A computer-readable storage medium storing a computer program for implementing a method for providing a customized personal health service, the method comprising:
searching a health group database for one or more similar cases, based on individual health information; and
predicting a personal health pattern from found similar cases,
wherein the similar cases are searched for in a health group database that stores pieces of time-series health information for respective cases, the time-series health information enabling variations in numerical values of respective pieces of health information within a range of a predetermined period to be detected.
